(19) United States
(12) Patent Application Publication
(10) Pub. No.: US 2018/0018634 A1
(43) Pub. Date: Jan. 18, 2018

(54) SYSTEMS AND METHODS FOR ASSESSING AN INDIVIDUAL IN A COMPUTING ENVIRONMENT

(71) Applicant: Altimetrik Corp., Southfield, MI (US)

(72) Inventors: Madhavan Satagopan, Bangalore (IN); Giridhara Madakashira, Bangalore (IN); Rakesh Ranga Nath, Bangalore (IN); Suresh Nair, Bangalore (IN)

(73) Assignee: Altimetrik Corp., Southfield, MI (US)

(21) Appl. No.: 15/704,932

(22) Filed: Sep. 14, 2017

(51) Int. Cl. G06Q 10/10; G06Q 10/06

(52) U.S. Cl. CPC G06Q 10/1053; G06Q 10/063112; G06Q 10/06398

(57) ABSTRACT

Embodiments disclosed herein relate to data analytics system and more particularly relates to a system and method for assessing an individual in a computing environment. Accordingly, the system receives a first set of objects along with a first set of test inputs, from a user device; analyses received first set of objects and the first set of test inputs corresponding to the first set of objects; retrieves a set of relevant data corresponding to the first set of objects based on the analysis; determines first test results based on the set of relevant data and the first test inputs; provides build environment to the user device based on the first test results to receive a second set of objects; evaluates the second set of objects with the first set of objects; computes overall score based on a first score and a second score.

### TECHNICAL FIELD

Embodiments disclosed herein relate to data analytics system and more particularly to systems and methods for assessing an individual in a computing environment.

### BACKGROUND

Considering an example scenario, certain tasks such as booking, ordering, shopping, and so on, are performed by a user using a mobile application. The service providers have to build a mobile application considering many aspects of such tasks. For example, a service provider is providing a particular service such as booking a cab, and the supporting services such as e-commerce, supply chain, banking services is provided by other service providers for booking the cab. However, all the essential services must be collaborated in one mobile application or website to book the cab. To leverage a platform, it is required to integrate with third party systems/applications.

In general, for the problem as disclosed in the above example, a workforce is required to have good knowledge of the real world problems. The workforce must possess good approach and skills towards solving the problem to work on the platform. The workforce should have the ability to combine art, engineering and the technology. Accordingly, the workforce must gather the customer experience and problem, to ensure improvement using the required process. Also, the workforce could use the Application Programming Interface (API), infrastructure or the platform in a consumer centric manner. However, the workforce may not achieve the requirement, specification, delivering a project in a structured manner.

Accordingly, the service providers are looking for a workforce to understand the problem, and find the solution by using minimum technology. If the workforce has to transform, they need to start thinking away from the requirements, even in the absence of the requirement. The workforce must be assessed for their thinking capability, solution, application of design principle, learning capability, combining the existing components, technical competency, soft skills etc. In conventional systems, there exist, interviewing technique, scenario based simulation, paired programming, interview base on questionnaire. However, these traditional systems may not access the candidate or workforce with problem solving skills, and thinking capability.

The conventional systems disclose a process to evaluate the performance of an individual by collecting behavioral information, compiling and analyzing the data to calculate performance measures for the individual based upon the behavioral information collected and converted into data and generating an output reporting the resulting performance measures. Further, the conventional systems can perform analysis such as social connectivity, community discussions, calcification of the context, and so on.

### BRIEF DESCRIPTION OF FIGURES

Embodiments herein are illustrated in the accompanying drawings, throughout which like reference letters indicate corresponding parts in the various figures. The embodiments herein will be better understood from the following description with reference to the drawings, in which:

FIG. 1 illustrates a system for assessing an individual in a computing environment, according to embodiments as disclosed herein;

FIG. 2 illustrates a detailed view of the data processing system as shown in FIG. 1 comprising various modules, according to embodiments as disclosed herein;

FIG. 3 illustrates a architecture of the data processing system, according to embodiments as disclosed herein;

FIG. 4 illustrates a flow diagram of the method for assessing an individual, according to embodiments as disclosed herein; and

FIG. 5 illustrates a computing environment implementing the method and system for assessing an individual, according to embodiments as disclosed herein.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

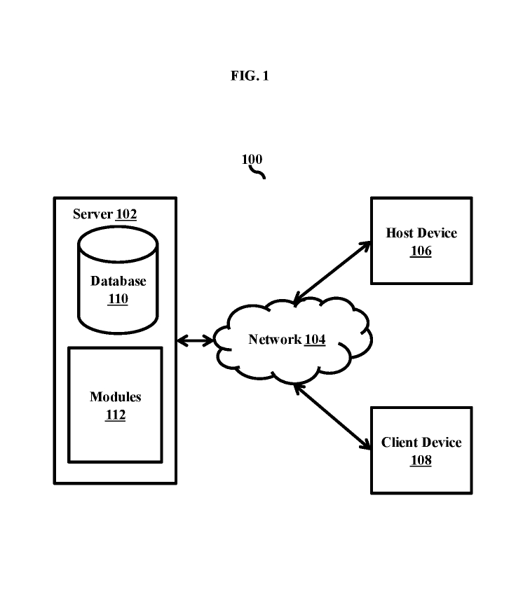

The embodiments herein disclose systems and methods for assessing an individual based on a set of data objects and scores associated with the individual. Referring now to the drawings, and more particularly to FIGS. 1 through 5, where similar reference characters denote corresponding features consistently throughout the figures, there are shown embodiments.

Embodiments herein disclose systems and methods for assessing an individual based on a set of data objects and scores associated with the individual. Embodiments herein disclose a platform for assisting an individual in completing a task initiated by a task owner, wherein the platform can be at least one of a web based platform, an application, and so on. Embodiments herein disclose systems and methods for providing an interactive platform for an individual and a task owner to communicate and collate common point of interests. Embodiments herein disclose a virtual assistant for assisting an individual for generating one or more data objects such that the task owner can assess the skills of the individual based on the generated one or more data objects;

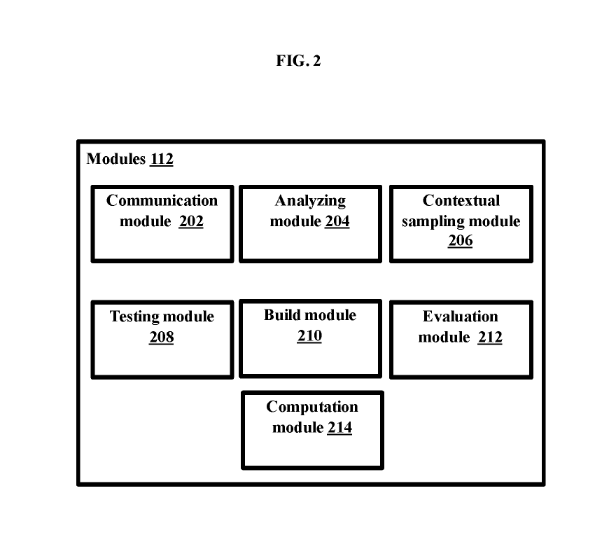

FIG. 1 illustrates a system 100 for assessing an individual in a computing environment, according to embodiments as disclosed herein. The system 100 comprises a server 102, a host device 106 and a client device 108. The host device 106 and the client device 108 are connected to the server 102 via a wireless communication network 104. The server 102 may be at least one of a standalone server, a cloud based server or a remote server. The server comprises a database 110 and module (s) 112. A detailed view of the server 102 is shown in FIG. 2. The server may comprise a processor, a memory, a storage unit, a communication interface, a display interface and so on.

Examples of the host device 106 can be at least one of, but not limited to, a personal computer, a mobile device, a desktop computer, a tablet, a phablet, an IoT (Internet of Things) device, a wearable computing device, a vehicle infotainment system, and the like. Examples of the client device 108 can be at least one of, but not limited to, a personal computer, a mobile device, a desktop computer, a tablet, a phablet, an IoT (Internet of Things) device, a wearable computing device, a vehicle infotainment system, and the like. The host device 106 and the client device 108 may comprise a user application interface (not shown in FIG. 1). The host device 106 and the client device 108 may comprise other components not shown in the FIG. 1 such as a processor, a memory, a storage unit, a display interface and a communication interface respectively.

The host device 106 and the client device 108 can run a client side application respectively establishing a communication session with the host device 106 and the client device 108, and the server 102 via the network 104. A user associated with the host device 106 first registers with the server 102 and creates a user profile. The user profile of the user of the host device 106 can be then assigned a set of privileges specific to the user (also referred as ‘host user’) of the host device 106. For example, the host user may be an interviewer interviewing a candidate. Similarly, a user associated with the client device 108 first registers with the server 102 and creates his user profile. The user profile of the user (also referred as client user) of the client device 108 is then assigned a set of privileges specific to the client user. For example, the client user may be the candidate being interviewed.

Based on the user profile, access to specific sections of the platform at the server 102 can be provided to each user. In an example, interviewers are allowed to view the evaluation results of the candidate and provide a score to the candidate for an activity. The candidate is given access only to view the activity assigned to him. The activities assigned to the candidates can be in the form of data objects. For example, an activity assigned to a candidate may be to solve a circuit diagram and the data objects for this activity may be components required to solve the circuit diagram. In other words, the data objects are inputs given to the candidate by the interviewer, which helps the candidate, solve the activity. This activity can be assigned by the interviewer to the candidate through the server 102. The activity may be problem statements in sentence forms. For example, what is the output of a circuit containing a NAND gate with an XOR gate. Prior to transmitting the activity to the candidate, the server 102 can segment this activity, which is in the form of sentence and can map each segmented word of the sentence to a predefined data object stored in the database 110. Based on the mapping, the server 102 can generate a data objects file containing the data objects relevant to the words in the activity received from the interviewer and can then transmit the data objects file to the client device 108.

The client user at the client device 108 can analyze the data objects file having the data objects generated based on the activity, and can try to solve the activity related to the data objects. After solving the activity, the candidate can push the solution for the activity in a specific sequence in the form of solved data objects to the server 102. The server 102 can further analyze this solution received from the client device 108, and can retrieve a set of relevant objects for the solution received from the client device so as to test the relevant objects to check if the solution can be worked or not. If the test results are positive, then the server 102 can generate a next set of data objects related to the activity and can transmit the next set of data objects to the client device 108 to solve the activity.

Here, the client device 108 solves the activity sequentially, where a solution to the circuit is tested in many phases. Once the client user solves the entire activity, the server 102 can compute a score for performance of the client user and can communicate the same to the host device 106. For example, the candidate registered/applied for a technical team lead designated vacancy position; the evaluation of the candidate is based on the raw technical capabilities. In an embodiment, the score for performance of the client user may be computed by evaluating the provided answers by the client user, for example, multiple choice questions, asynchronous puzzles and provide scores, negative marking etc. In an embodiment, the asynchronous puzzles maybe computed by asynchronous method in which a mentor or a host user may evaluate the solved complex puzzle scenario. The approach or performance towards the solution of a given problem could be evaluated based on logical correctness, rigorousness and so on. The score maybe combination of various such metrics. This score is the first score. Based on the first score, the interviewer or host user at the host device 106 generates a second score. The second score is a soft score based on interactive and intelligence test to evaluate the psychometric capabilities. Based on the first and the second score, an overall score is generated and displayed at both the host device 106 and the client device 108, thereby making the process of interview transparent to both the interviewer and the candidate.

In another embodiment, the score may be computed by at least one of the category index such as intellectual index (I), compatibility index(C) and emotional index (E) to result in a cumulative score of ICE score. The intellectual score maybe computed from raw test scores. In an embodiment the I score may be computed by combining the number of correct answers (i.e. N_{C}) provided by candidate, the number of wrong answers (i.e., N_{W}) provided by the candidate and further, along with weighting α, such that the score(s) is,

s=F(N_{C},N_{W},α)

Where, F( ) is a linear/non-linear function. In another embodiment, the type of F is selected based on complexity, the number of candidates. The score is then used to compute the relative standing of the candidate using at least one of the methods such as percentile, discriminant analysis, clustering etc. In an embodiment, the computed relative standing maybe translated to scaled Grade Point Average (GPA) score. Further, the GPA score can be used as the intellectual score or I index.

In another embodiment, the C index can also be simultaneously computed along with the I index. The C index can be computed by the computation module. The C index can be a quantitative measure of the interaction quotient of the candidate. In an embodiment, the interaction quotient can be measured to determine the interactive compatibility of the individual candidate. The individual compatibility of the candidate can be constant over multiple interactions by the candidate. Further, the multiple interactions can be determined by the emotional content of messages, chat logs and personnel interaction. In another embodiment, the emotional content can be measured by creating a phrase emotion mapping method. In an embodiment, the mapping method includes the following process: a) identifying the phrases that have a high probability of expressing emotional content and are assigned a polarity.

In an embodiment of the polarity for the emotional content can be performed by analyzing the emotional content by at least one of Natural Language Processing (NLP) method and Machine Learning (ML) using the computation module. b) determining the emotion in each of the phrases that have sufficiently high polarity. Further, the emotions can be classified as positive or negative emotion using a Bayesian classifier method, c) computing sum of positive and negative emotional polarity score. Furthermore, the computed score is compared across different levels of interactions of the candidate in terms of hierarchy. Additionally, a dot product is computed such to determine whether the emotional score is consistent or not. If the emotional score is consistent, then a high emotional index is outputted. The high emotional index is referred as the C index. The C index as indicates that there is no emotional assessment made for the candidate.

In an embodiment the E index corresponds to a plurality of emotional assessments in the ICE score. The E index is computed from the emotional score associated with the C index. In an embodiment, raw phrases including a positive and negative polarity values are obtained, and segmented into following categories, a) Emotion (È) b) Mood (M) c) Attitude (A) and d) Personality (P) traits. Each of these is assigned grades or sub categories. Basically, the category emotion can be diversified as angry, sad, joyful, fearful, ashamed, proud, elated and desperate as known in the art. In an embodiment, the category mood is further classified as cheerful, gloomy, irritable, listless, depressed and buoyant. Further, the category attitude is classified as liking, loving, hating, valuing and desiring. Also, the category personality are classified as nervous, anxious, reckless, morose, hostile and jealous. Further, the E index is computed by combining the above classifications numerically. Such classifications are derived from the two main sources, namely, a) chats and logs b) psychometric tests. In an embodiment, the psychometric test may measure some part or all of the above attributes, if the above attributes are not measured, the computing module may evaluate the chat logs of the candidate. Additionally, the E index may be computed by evaluating the interaction of candidate with others candidates. In an embodiment, the computed score in each category and subcategory by the Bayesian analysis method, a specific sub-trait may be selected for each category. Further, each subcategory is assigned a weight i.e. β. The weight can be high positive or high negative. The decisions of weights are performed by the configuration user. Subsequently, when the categories ÈMAP are considered as scores of each trait conformal mapping function is applied as below:

E=F(β·\grave{E}, β·M,β·A, β·P)

where β is the weighting factor. F(.) can for instance be a summing function that is determined by the complexity of the hiring/selection process and the seniority/sensitivity of the task performed by the individual. In another embodiment, the final decision is made based on a cumulative ICE score. The ICE score includes I index, C index and E index. The three indexes are combined to obtain a weighted sum and further scaling as desired. Configuration user decides the weights such as W_{I}, W_{C}, W_{E}. For example, the hiring/selection of candidate for a senior designated post in the company, it may be necessary to underplay technical skills and consider only the emotional and compatibility aspects. In such cases the configuration user may appropriately tune the weights. The platform as disclosed herein can be at least one of a web based platform, an application resident on the host device and the client device, and so on.

FIG. 2 illustrates a detailed view of the data processing system 102 as shown in FIG. 1 comprising various modules, according to embodiments as disclosed herein. The server 102 is also referred to herein as a data processing system 102, as shown in FIG. 1. As described in FIG. 1, the server 102 comprises the modules 112. The modules 112 may include a communication module 202, an analyzing module 204, a contextual sampling module 206, a testing module 208, a build module 210, an evaluation module 212 and a computation module 214.

The communication module 202 can be configured to receive the first set of objects along with the first set of test inputs, from the client device 108 via the communication network 104, wherein the first set of objects includes at least one combination of a drivers, plug-in, network objects, virtual objects corresponding to the circuits and machines. The communication module 202 can be further configured to receive the second score from the host device 106 based on the evaluation of the first set of objects and the second set of objects. The communication module 202 can be further configured to receive the second score from a host device 106 communicatively connected to the client device 108 based on the evaluation of the first set of objects and the second set of objects. The communication module 202 can be further configured to receive and store an activity data of the at least one user device (such as the host device, client device, and so on), wherein the activity data comprises forward and backward compatibility of objects, combining the objects in proper form, improvements performed in the design the objects, using the virtual assistant, usage of expert opinion, errors, incorrect build, engineering limitation.

While receiving the first set of objects along with the first set of test inputs from the client device 108, the communication module 202 can be further configured to transmit initial data objects received from the host device to the at least one user device based on user profile of a user associated with the at least one user device; and receive in response to the initial data objects the first set of objects from the client device 108 along with the first set of test inputs.

In transmitting the initial data objects, the communication module 202 can be further configured to identify relevant data objects corresponding to the initial data objects received from the host device 106 based on key word analysis; and transmit the relevant data objects to the client device 108.

The analyzing module 204 can be configured to analyze the received first set of objects and the first set of test inputs corresponding to the first set of objects using a data science method. The data science method is used for classifying, predicting and suggesting the relevant objects for generating the relevant data corresponding to the first data objects. Further, considering the data science method, the classification could be related to peer ranking, wherein the classification is based on baseline attributes such as minimum soft score, minimum technical score and basic overall score. For example, different candidates with different skill sets will be mapped to scores. In one example, the developer role recruitment will have higher soft skill scores and poorer technical scores; however, the acceptable overall score will be present. Further, if a candidate has very good technical score as compared to the average then the candidate should be classified as exceptional even if the candidate overall score is marginally better than other candidates.

The contextual sampling module 206 can be configured to retrieve a set of relevant data corresponding to the first set of objects based on the analysis to test the first set of objects based on the set of relevant data and the first test inputs. The testing module 208 can be configured to determine first test results by testing the first set of objects based on the set of relevant data and the first test inputs. The test results are determined a-priori based on statistically insignificant tests. In an embodiment herein, the test results can be scrutinized by subject matter experts at the host device 106. The build module 210 can be configured to provide a build environment to the client device 108 based on the determined first test results to receive a second set of objects from the client device 108. For example, in the initial test, the candidate performs better in the testing in one specific aspect of the technology such as theoretical solidity in certain concepts over others, the candidate can be provided with an environment and use case scenario based on the solid principles. The theoretical solidity can be tested with a set of questions that are meant to be answered only if the candidate has knowledge of fundamental subjects. The evaluation module 212 can be configured to evaluate the second set of objects received from the client device 108 along with the first set of objects previously received from the client device 108.

The computation module 214 can be configured to compute a first score based on the evaluation of the first set of objects and the second set of objects received from the client device 108. The computation module 214 can be further configured to compute an overall score based on the first score and the second score. The second score can be computed using a capability score, a nonlinear bivariate map, and a scientific and technical validity value of a test case object. The first score and the second score can be computed based on technical ability to solve a problem of a user, mind state of the user, and approach towards the problem.

In an embodiment, the module 110 can also include a virtual assistant manager for configuring a virtual assistant at the at least one user device to assist a user at the at least one user device.

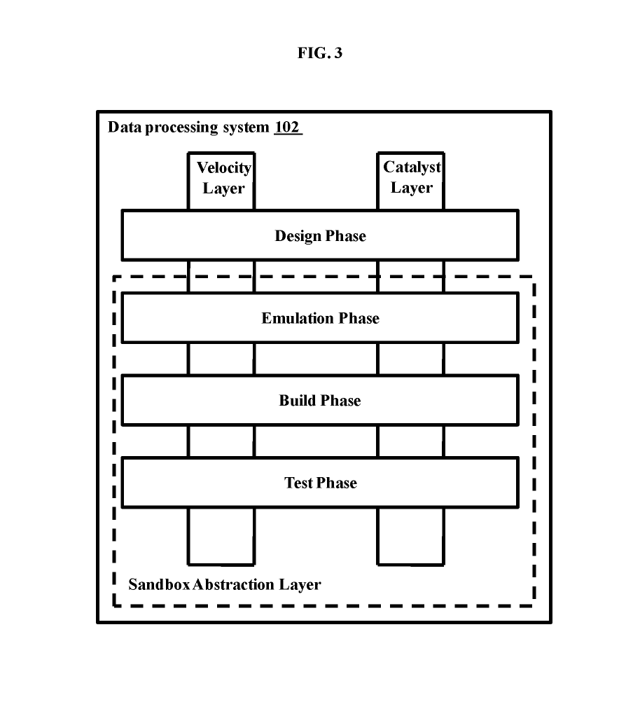

FIG. 3 illustrates architecture 300 of the data processing system 102, according to embodiments as disclosed herein. The architecture of the data processing system, such as the server 102 can be referred to as a sandbox. The sandbox comprises a sandbox abstraction layer, a design phase layer, a velocity layer and a catalyst layer. The sandbox is the direct interaction layer for the host user and comprises of the following phases of operation:

A conceptualization phase or a design phase, where the conceptual elements are clearly enunciated and described.

An emulation or whetting phase, where the conceptual elements are brought together within an emulation environment. The emulation environment at this stage is provided by the server 102 that records the interactions between the host device 106 and the client device 108.

A build or construction phase, where the emulated and correspondingly modified elements are built with real world components also referred as first data objects and second data objects. In this phase, the build components comprise of both hardware and software components, which replicate the real world components.

A load testing or quality evaluation phase, which is the testing phase in which the components formed in the build phase are tested. In this phase, real world scenarios are accurately tested. Testing in this phase is mainly based on business rules.

In an embodiment, the conceptualization phase comprises of the following objects such as whiteboards with demarcated thought flows, touch screens embedded with software that allows creation of interactional objects, 3D map projections with specific design elements, and so on. The purpose of this phase is to break an idea into the following aspects such as a complete workflow in terms of stages involved. Displaying the conceptual elements in the workflow, which include the data objects and processing objects. Dividing the elements into categories such as physical objects, network objects etc. Further, in this phase, the emulation test cases need to be correctly defined. For the emulation phase, the conceptual elements or parts of assembled. Once the system is assembled, the system has to be tested. Further, the next step in the conceptualization phase is to determine test inputs that can be generated. This requires the stakeholder or participant henceforth to understand the background of the elements being constructed. Within this background, the candidate constructs limiting conditions that are motivated purely by design, and not by real life. For example, the limiting conditions by design imply conditions such as, to identify the proper solution by the candidate in an ideal use case scenario. In one example, the wing design of an aircraft is meant to withstand 5 atmospheres of stress if the wing loading is significant. In the real life scenario there is no need to consider such a situation.

In an embodiment, the emulation phase is a destructive test phase. The purpose of this phase is to push the design of elements to further designing phase. The emulator phase or the design test phase in which the testing is motivated by the need to do extensive testing rather than deployment. Testing for this can happen on a workbench (which can be an assembly area), wherein a general characteristic of such a workbench is an ability to generate large amount of data and store them locally as data objects. In an embodiment herein, intelligent caching can be enabled. Further, embodiments herein disclose an intelligent assistant, which possesses the ability to spontaneously recognize drivers, plug-in requirements and configure the build environment and providing various executables, API objects, and so on, to interconnect and play with each other.

In another embodiment, the interplay of elements is decomposed into elements in the conceptualization phase. The elements can have the ability to interact with one another, to execute the independent tasks efficiently and finally survive the test. A velocity layer can also play a role, during this evaluation. The velocity layer can track the differential interactions at each stage. In some cases, the interaction is initially not direct; however, in other cases, the interaction can improve and a large amount of collaborative work can be performed. Evaluation can be considered on two broad criteria such as hard or technical skills measured by a C-score also known as the first score, soft or non-technical skills measured by an S-score also known as the second score. Further, the two scores can be combined as

C=f(σ,Σ)

Where ‘C’ is a capability score. ‘f (.)’ is a non linear bivariate map which is identified based on user I interaction. ‘σ’ is computed from scientific and technical validity of a test case and ‘Σ’ is computed from the approaches taken for these cases, using a conventional computation method. Considering, the client user may provide solutions to the test; σ may compute absolute errors, where as Σ may compute the efforts made by the participant or client user to correct absolute errors. For example, the client user maybe trying to design the sensor solution and the client user may provide a different sensor other than expected sensor to the provided problem. The Σ may compute a high error, however if the client user replace the sensor, then the Σ may be high and the combination could result in a high capability score. The approach to the problem or correcting the mistake performed by the client user may be monitored.

Both are scaled to 0.0 to a 4.0 scale, with 0.0 being well below expected average and 4.0 being the top performer. It is a statistical percentile score in the areas of evaluation. Areas of evaluation can be decided by the participant based on their specific test scenario. Alternatively, ‘Σ’ is computed from the soft skills exhibited. These soft skills can be computed on the following baseline parameters, calmness and poise of participant in approaching the problem; emotional and psychological profiles when faced with success or failure; willingness to learn, admit mistakes and general awareness of their state of solution.

Other than this if a group interaction is called for, and then their group dynamics can also be analyzed.

In yet another embodiment, evaluating strengths and weaknesses of individuals or candidates specific to building an idea, post conceptualization and testing the idea with data, can be considered as evidence of the commitment of the participant. The score is the first moment of C, dC. The first moment quantifies how C is approached, it incrementally adds to the personality of the participant stored in the database. This allows the system 102 to quantify parameters such as strengths of the participant as evidenced by participant or candidate, strengths of the participant as envisioned by participant or candidate, weaknesses known to the participant, weaknesses exhibited that the participant, and so on. A quantitative measure of these four parameters contributes to dC. The quantitative measures can be computed by the knowledge of the candidate estimated skill values, and based on the skills the test is populated to evaluate the skills. The known strengths and weaknesses can be weighted higher in this index because it implies a well-rounded, grounded personality. A higher dC can imply a stable and confident person. A very low dC can imply either an overconfident or under confident person. Further segmentation and analysis can help break the degeneracy.

In yet another embodiment, a task execution skill diagram can be created with N dimensional matrix of values for N tasks. Further, the tasks and tests can be designed to evaluate the skills, a task class table and skill class tables can be created. Each skill is mapped to one or more tasks. The candidate's use of said skill in each task is encapsulated within the task definition. The execution of each such skill capsule can be evaluated. Typically each task could be an evaluation of specific skills, which the candidate claims to possess. The matrix can be written as,

M=C·dC

Where is a dot product. M is then projected into a Venn diagram. The Venn diagram is a combination of C and dC that can be marginalized over tasks and give a unique matrix of combinatorial statistics of skill evolution and its usage. Since this is marginalized over tasks, what is observed is the evolution of C and dC over individual problems. If the initial parameter space C is tasks, score and problem number, and dC is rate of change of score over tasks and problem number, then M is the rate of change of score and problem number. In one example, for Venn diagram, considering two circles C and dC interlocked to one another. C could bean intersecting circle such as skill1; skill2 etc. dC could be an intersecting circle such as Task1.Skill1, Task2. Skill2 etc. Further, the dC is computed within the intersected circles and further the intersection between C and dC is computed.

Once the emulation phase has had acceptable results within a percentile rating, then the build phase is initiated. In the build phase, elements developed in the conceptualization phase are built considering real world problems. This phase involves the following operations such as combining elements with real world objects, wherein the elements can include both hardware and software elements. These elements can be forward and backward compatible in the chain of events. This means that elements, which are developed in the build phase, can have design changes enforced by emulation phase results and other scenarios. All of these are tested in the emulator phase and brought forward with changes. Design aspects in this phase can be ecosystem driven. The systems used in this phase include, but are not limited to, element integration such as soldering irons, breadboards, CROs, load testing equipment, manufacturing such as lathes, supercomputing scheme for computation based problems, and so on. Further, the data processing system 102 can configure an integrated build environment. Solution of the aspects of this build environment that need to be configured can be provided by the emulator phase. The velocity layer can inform the participant of the best choices for the build phase based on their results. The participant or candidate can, in turn inform the institution of the needs of their build phase.

The build phase comprises of the following steps such as an assemble step where all the necessary elements are manufactured and brought to the workbench. On the workbench, the components can be ordered and labeled for design changes. Further, in the emulation phase, a design update can be performed, followed by testing the change. The design validation at the emulation phase implies a new design that is assembled and built. At the end of assembly, the velocity layer can evaluate the engineering of the solution. C now is modified to be a Ce, such that

C=Ce

Ce=F(C)

Where F (•) is a conformally mapping function. The metric C developed as a pure design evaluation metric is now converted into a design innovation metric. Conformal mapping functions can be generated using analytical techniques which analyze the data from the velocity layer based on the criteria for improvement in design and scores from the innovation in design. For example, if a design for a sensor is conceptually developed in the design phase, it could be engineered in the emulate phase and score can be computed by subject matter experts through host device 106. The score can be correlated with the design score. In the case of design score is being high, the historic data is considered for translating to engineering score. This is computed using machine learning and other analytic methods, which is F (.).

In a load testing phase, the actual real world values can be tested in a controlled environment. The controlled environment can include an automated data generator that can be generated from the velocity layer based on results from emulation and build phase, a semi-automated test script generator (which can either be based on known business use-cases or can be generated from user defined test scenarios), a database and repository to record responses of the built system. The automated data generator comprises of the following aspects, such as an automated sampler (such as the Metropolis-Hastings algorithm), a randomized model selection means (such as Markov Chain Monte Carlo modeling scheme), pseudo randomized ensemble modeling schemes (such as a Gaussian data model), and a sampling and model combinatorics engine. The semi automated test script generator includes a test scenario condition evaluator that auto generates based on factors such as a historical and contextual data, a suite of test scenarios in terms of limiting conditions, a data population engine that organizes the data, based on the data required by the client user at the client device 108, from the data generator to precisely cater to test scenarios, and a semi-automated system that displays the result grades based on the user defined acceptability criterion. The load testing phase can reuse test scripts developed in the emulator phase.

In another embodiment, the velocity abstraction layer has immediate access to data generated from the sandbox. It has the ability to create user profiles and update personas. It also connects with the catalyst layer to create a skill diagram based on the analysis performed in the velocity layer. The velocity abstraction layer can be the digital and data support for the sandbox abstraction layer. The velocity layer includes an analytics platform to perform functions such as fundamental predictive analytics, offer personal assistance (which can be based on AI.3), and so on. The personal assistance can be in the form of a voice based digital assistant that is personalized to each participant. The velocity layer can include a component repository that is NLP enabled within-built ranking and classification methods. The velocity layer can also offer audio-visual feedback capability.

The velocity abstraction layer computes the C and S scores. The velocity layer is the intermediate layer between the physical components of the sandbox and the digital attributes of the participant such as the C score. Additionally the velocity abstraction layer connects with the catalyst abstraction layer in order to generate deeper insights into the participant's progress. The physical layer is the instantiation of the fully abstract digital ideation phase enshrined in the velocity layer. The velocity layer thus forms the digital embodiment of the sandbox. It abstracts the following activities away from the sandbox; testing bases for the ideas conceived by the participants, data consolidation based on measurements and metrics, hand holding assistant or supervisor or an external overseer, necessity to monitor multiple simultaneous activities with massive man power, objective and holistic monitoring basis for all activities. In another embodiment herein, the role of the velocity layer at each sandbox phase includes a virtual assistant for the conceptualization phase, wherein the conceptualization is not considered as a standalone phase. The conceptualization is meant to make the participant more aware of their strengths and weaknesses. Within the conceptualization phase, the participant logs their steps with the digital assistant. The digital assistant offers insightful questions without interrupting, guiding or manipulating the thought processes of the participant. This can result in a series of discrete steps that are logged in with comments in the form of responses. A NLTK (Natural Language Toolkit) analyzes these responses and quantitatively assess the progression of steps for two basic attributes such as the coherence of logical arguments in terms of how steps are connected. This computes factors such as how ergodic the steps are, the resistance to analysis and the willingness to alter steps if they don't seem to be converging to the pre-designed goal, shifting of goal posts is performed by the velocity layer to suit the participant, and so on. A large shift towards the end of the process can be documented and analyzed by the catalyst layer. In an embodiment herein, the participants can be informed of the changes, coherence of logical arguments, and so on, at an intermediate steps, say after N steps have been analyzed, where N is a number that is computation dependent. The analysis can be performed jointly by the velocity and catalyst layers. Participants can only be informed of the shift and logical coherence, without any bias. The purpose of providing this information is to keep the participant keyed in to them, at the same time ensuring that no changes can be made by the participant. The shifting of goal posts on the other hand is analyzed for the following, such as was the shift as a result of an unreasonable expectation, and was the shift a result of poor initial framing of the problem, how much fraction of the shift was caused by the participant not following through on an idea, and so on. These can be computed quantitatively by fitting probabilistic models or subject matter experts. Probabilistic models compute the following quantitative entities such as deviation from best possible next step by participant, time spent in making this deviation (i.e., was sufficient time spent making a non-rational choice), sufficient number of arguments offered by the participant to make this deviation, concurrency of arguments to the deviation, and so on. The computation is based on Bayesian probability measures. At the end, when the final step has been frozen, the velocity layer can logically evaluate the entire chain of steps, wherein the evaluation can be based on Markov chain analysis. The velocity layer can generate a manifold model to quantify the generative logical steps created by the participant. The velocity layer can store the generated model in the catalyst layer.

A digital workbench can be considered as a presentation of the actual workbench in terms of components. The digital workbench can comprise of add on tools, design augmentation, feedback to the participant in terms of feasibility of design, and so on. The digital workbench contains, an embodiment of a digital environment composer that ‘puts-together’ a basic environment that is capable of testing the solution.

For instance, a solution for a saltwater purifier, which works on an ocean with varying amount of salinity. In addition, the conditions can vary such as seasonal changes, pollutant, changes in the salt water, water pressure and so on. An embodiment of a digital assistant is imbued with the basic background knowledge and queries the search results. In the saltwater purifier solution, the assistant can discriminate between questions related to salinity and questions related to salinity sensitivity of the equipment and appropriately return SEO (Search engine optimization) queries to make it noteworthy for the participant. For a saltwater purifier, a component repository query engine queries a digital electrolysis machine with emulators for different metallic electrodes being deployed. The participant inputs the instance values. For a saltwater purifier, the purification is a function of the efficiency of the electrodes which can be a combination of various variables such as temperature, salinity, electrode type, time of running, power available and so on. With the help of an expert opinion, the environment can generate realistic outputs that are expected with ideal operation. The participant runs this methodology and then comparisons can be made. An embodiment of a report generator for the participant, which suggests design improvements. Improvements in design can be motivated by the expectation condition suggested by the offline expert. An important aspect of the digital workbench is the ability to leverage expert opinion. Before embarking on the emulation phase, the participant can be expected to have clear questions regarding the domain of his solution. These questions can be conveyed to an external interface (which can be an SI conversation bot), which in turn can leverage domain experts. Questions are relayed to the expert, who provides answers. Answers can be converted by the external interface into a concept/word cloud. The word cloud contains key concepts espoused by the expert. The concept cloud is a word cloud with ranking in terms of importance of certain non-grammar key words, which can be expected to play a key role in the development and addressing of the solution. The participant is expected to understand these key concepts in the context of the solution. Additionally when the external interface is invoked with questions, the interface scrapes the answer set and creates a broad concept set that is offered to the participant, wherein the broad concept set can be offered based on NLP searches of resident documentation. If the participant is unable to still understand the concept and is stuck with the domain, then he can be connected to the expert.

The digital workbench can project the build environment requirements of the solution. Projections of these requirements require actions such as analyzing results from the emulation phase to present the best possible build for the solution. In the case of the saltwater purifier, this means ascertaining the best electrodes and so on, for the method suggested by the participant. This can include fine-tuning the available market components to fit the solution, and preparing test scripts to run in the load testing phase based on real world scenarios and the use-case suggested by the participant. While projecting these requirements, the velocity layer also internally performs housekeeping tasks, such as consolidating results of different tests, asking for comments, discussions and conclusions from the participants, identifying the key aspects of the method, and so on. These actions can be then cast into a publishable format, with NLP categorizing these actions into categories such as methods, discussions and conclusions. The participant can either, continue onward and build their solution for deployment or publish the result and terminate the interaction.

In another embodiment the velocity abstraction layer comprises of a digital assistant for the build phase. In this context, the velocity layer performs tasks such as recording the engineering journey in terms of comments, measurements, errors made by the participant, and so on. In this, the participant is not encumbered with having to write logs, perform context switches, cataloging changes in design and intimating for new test scripts based on participant input, cataloging deviations, incorrect builds and engineering limitations, and so on. Once these details are properly cataloged, the participant can be presented with a report of their progress on their terms. The digital assistant does not perform any analysis, but merely informs the participant about the results of the analysis in an organized format, wherein the format can be a representation of the skill-task diagram. The expectation from the participant is that the engineering journey should objective. The digital assistant then invokes the test script generator for the next phase.

The test script generator can be semi-automatic. It creates a digital assistant that interacts with the participant to generate test scripts. The digital assistance enables the participant to be freed from the effort of having to worry about design details such as whether testing has to be whitebox or blackbox and so on. The test script generator designs an appropriate testing scheme without bothering the participant with details. The design of the test script can be performed based on input from user in terms of the aspects the candidate requires for testing. The test script generator can perform actions, such as analyzing the design changes from the emulation phase, consulting participant(s) about changes to the test scheme based on design changes, generating test scripts for the load phase, cataloging results of the load phase tests, and so on. Test scripts generated in this phase can be constrained to use-case. If business or domain rules exist for the use-case, then the test scenario is precisely tailored to those rules. NLP engines interpret the requirements to generate limiting parameters whose limiting values (or functions) are stated by the participant. Test scripts can be generated only to test a limited set of scenarios that reencountered during implementation. The domain rules reasonably rule out which scenarios are irrelevant to the intended recipient of the solution. For example, the aircraft wing design is expected to be designed for a specified size of aircraft.

The velocity layer finally catalogs, segregates and reports the results. This is the handover step of the velocity layer, where the layer does not perform any more analysis, but merely reports the results from all the tests in an organized manner. The velocity layer however, does not give any insight to the participant about himself.

The next step in data analysis is to analyze the personality of the participant. This can accelerate the personality development of various participants. The catalyst abstraction layer presents the participants with their overall strengths and weaknesses. The catalyst abstraction layer also informs the participants of their approach to these.

Embodiments herein disclose the ability to conceive of holistic skill sets by combining technical and non-technical skills. With a C score, Meta analytics can be performed to generate a unified skill index. In order to generate a skill index, the catalyst layer can consider the following inputs such as feedback absorbed during the conceptualization phase by implementing suggested changes, the scores returned for stability of persona etc. from velocity layer, degree of technical flexibility when faced with a dead end, ability to appreciate strengths and weaknesses when emulating the problem, effective use of the external interface, ability to accept failure by introducing design changes flexibly, and so on. Further, some of these inputs can be quantifiable directly from velocity; whereas some inputs are only qualifiable without any direct quantification criterion. An example of such criterion can be positive interaction between candidates; this can be viewed by looking at inter-participant chat logs and the observing overall positivity of interaction by the host device 106. The catalyst layer can convert these into quantified variables. Quantified variables can then be converted into a visual, which encapsulates data such as top 3 skill sets that can be quantified. Further, the tasks and tests can be designed to evaluate the skills; a task class table and skill class tables can be created. Each skill is mapped to one or more tasks. The candidate's use of said skill in each task is encapsulated within the task definition. The execution of each such skill capsule can be evaluated. Typically each task could be an evaluation of specific skills which the candidate claims to possess

Skills have been expressed in task types. For instance, strengths and weaknesses can be exhibited differently based on the task type. This is crucial to understand which specific skills need to be developed in task type.

Top participants for a specified skill type are then matched to task types. All task types need not have the same skill type and the same skill may not be expressed with the same confidence at different tasks.

A task based segregation based on skill dominance can be performed. Statistically the skills have been most dominant in performing certain types of tasks can be segmented into task segmentation and skill segmentation.

To this effect, the catalyst layer acts as a pan-phase layer. This layer utilizes data over multiple phases, entirely fed by the velocity layer. The collation of approach to the task can be based on incremental data. The catalyst layer can directly modify the persona of the participant. In order to do this, the participant needs to participate in a pre-defined minimum number of tasks. The number depends on the complexity of task, participation frequency and adherence of the participant. Once the initial data has-been collected, the catalyst layer first populates the approach aspect of the persona. Various parameters such as rigor, conscientiousness, clarities, and so on, can be populated. This can be performed based on parameter change incrementally from task to task, from the velocity layer.

For example, the cumulative estimate of versatility of participant is populated only when the participant has completed a minimum of 3 tasks in each task type. They also need to have at least one task in each task type.

Versatility is a measure of the breadth of a participant. Each versatility score can be computed as a CC score. A simple estimate of versatility could be thus

V=C·Σ_{T},

Where the CC score is dotted with the covariance matrix of the tasks.

The catalyst layer can determine a cumulative estimate of compatibility of participant over tasks. This could be the compatibility over multiple tasks for a participant, which can be considered as the converse of versatility. Task compatibility over a statistically significant number of tasks is a cumulative compatibility. Inverting the below equation and computing an expectation

C=E(Σ⁻¹_{T}×C)

To get an expectation of quantized values. The above equations are examples of how the catalyst layer behaves as a quantifier using statistical system properties. These are just brief examples of the operation of the catalyst. The list is not exhaustive and is dependent on deployment and location.

An important aspect of the experience of the playground is constant upgrade. Without succumbing to a tendency to fine-tune the workings, it is important an over arching perspective of where the experience of the participant and institution stands. An experiential wrapper works an overall umbrella that takes feedback in aspects such as usefulness of the feedback provided by virtual assistants, flags where suggestions by the system were downright out of context, comfort and ease of use, diction and language sensitivity, and so on. Feedback can be construed as action items such as an embodiment of online model update, an embodiment of improved voice cognition, and so on. The experiential wrapper can allow every instance to have its own unique areas of strengths.

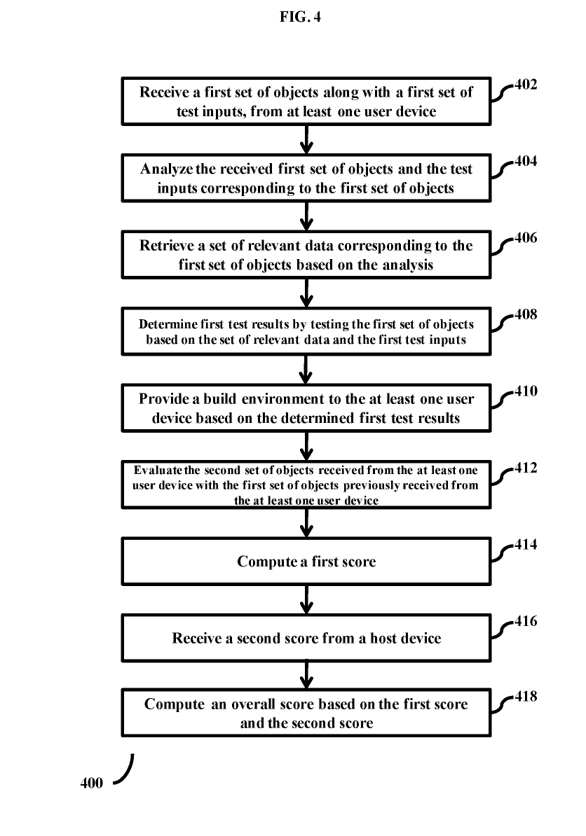

FIG. 4 illustrates a flow diagram 400 of the method for assessing an individual, according to embodiments as disclosed herein. At step 402, a first set of objects along with a first set of test inputs is received from the at least one user device (client device 108) via the communication network 104, where the first set of objects includes at least one combination of a drivers, plug-in, network objects, virtual objects corresponding to the circuits and machines. Further, in receiving the first set of objects, the server 102 is also configured for transmitting an initial data objects received from the host device to the at least one user device 108 based on user profile of a user associated with the at least one user device 108; and receiving in response to the initial data objects the first set of objects from the at least one user device 108 along with the first set of test inputs. In transmitting the initial data objects, the server 102 is configured for identifying relevant data objects corresponding to the initial data objects received from the host device based on key word analysis; and transmitting the relevant data objects to the at least one user device. At step 404, the received first set of objects and the first set of test inputs corresponding to the first set of objects are analyzed using a data science method. The data science method can be used for classifying, predicting and suggesting the relevant method for generating the relevant data corresponding to the first data object. At step 406, a set of relevant data corresponding to the first set of objects is retrieved based on the analysis to test the first set of objects based on the set of relevant data and the first test inputs. At step 408, the first test results is determined by testing the first set of objects based on the set of relevant data and the first test inputs. At step 410, a build environment is provided to the at least one user device 108 (or the client device 108) based on the determined first test results to receive a second set of objects from the at least one user device 108 (or the client device 108). At step 412, the second set of objects received from the at least one user device 108 (or the client device 108) are evaluated along with the first set of objects previously received from the at least one user device 108 (or the client device 108). At step 414, a first score is computed based on the evaluation of the first set of objects and the second set of objects received from the at least one user device 108 (or the client device 108). The first score and the second score are computed based on technical ability to solve a problem of a user, mind state of the user, and approach towards the problem. At step 416, a second score is received from a host device 106 communicatively connected to the at least one user device 108 (or the client device 108) based on the evaluation of the first set of objects and the second set of objects. The second score is computed using a capability score, a nonlinear bivariate map, and a scientific and technical validity value of a test case object. At step 418, an overall score is computed based on the first score and the second score. Further, the server 102 is also configured for receiving and storing an activity data of the at least one user device 108, where the activity data comprises forward and backward compatibility of objects, combining the objects in proper form, improvements performed in the design the objects, using the virtual assistant, usage of expert opinion, errors, incorrect build, engineering limitation. Also the server 102 is configured for configuring a virtual assistant at the at least one user device 108 to assist a user at the at least one user device 108. The various actions in method 400 may be performed in the order presented, in a different order or simultaneously. Further, in some embodiments, some actions listed in FIG. 4 may be omitted.

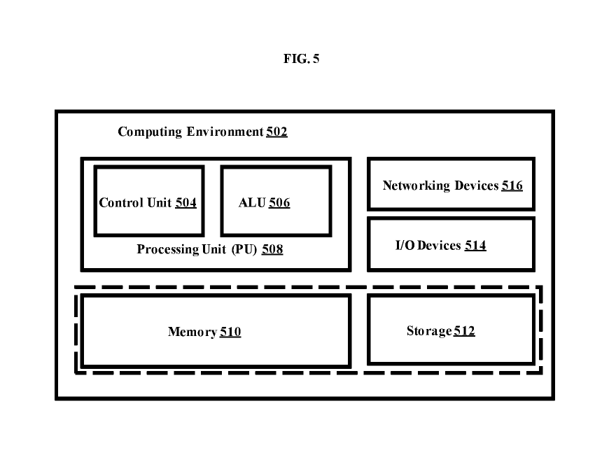

FIG. 5 illustrates the computing environment 502 implementing the method and system for assessing an individual, according to the embodiments as disclosed herein.

As depicted in the figure, the computing environment 502 comprises at least one processing unit 508 that is equipped with a control unit 504 and an Arithmetic Logic Unit (ALU) 506, a memory 510, a storage unit 512, plurality of networking devices 516 and a plurality Input output (I/O) devices 514. The processing unit 508 is responsible for processing the instructions of the scheme. The processing unit 508 receives commands from the control unit in order to perform its processing. Further, any logical and arithmetic operations involved in the execution of the instructions are computed with the help of the ALU 506.

The overall computing environment 502 can be composed of multiple homogeneous or heterogeneous cores, multiple CPUs of different kinds, special media and other accelerators. The processing unit 508 is responsible for processing the instructions of the scheme. Further, the plurality of processing units 508 may be located on a single chip or over multiple chips.

The scheme comprising of instructions and codes required for the implementation are stored in either the memory unit 510 or the storage 512 or both. At the time of execution, the instructions may be fetched from the corresponding memory 510 or storage 512, and executed by the processing unit 508.

In case of any hardware implementations various networking devices 516 or external I/O devices 514 may be connected to the computing environment to support the implementation through the networking unit and the I/O device unit.

The embodiments disclosed herein can be implemented through at least one software program running on at least one hardware device and performing network management functions to control the network elements. The network elements shown in FIG. 1 include blocks, which can be at least one of a hardware device, or a combination of hardware device and software module.

The embodiment disclosed herein describes a system and method for assessing an individual based on a plurality of scores computed at the server 102 and one or more data objects communicated between the host device 106, the client device 108 and the server 102. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in at least one embodiment through or together with a software program written in e.g. Very high speed integrated circuit Hardware Description Language (VHDL) another programming language, or implemented by one or more VHDL or several software modules being executed on at least one hardware device. The hardware device can be any kind of portable device that can be programmed. The device may also include means which could be e.g. hardware means like e.g. an ASIC, or a combination of hardware and software means, e.g. an ASIC and an FPGA, or at least one microprocessor and at least one memory with software modules located therein. The method embodiments described herein could be implemented partly in hardware and partly in software. Alternatively, the embodiments herein may be implemented on different hardware devices, e.g. using a plurality of CPUs.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of embodiments and examples, those skilled in the art will recognize that the embodiments and examples disclosed herein can be practiced with modification within the spirit and scope of the embodiments as described herein.

We claim:

1. A system for assessing an individual, comprising:
a processor; and
a memory coupled to the processor, wherein the memory comprises:
a communication module configured to receive a first set of objects and first set of test inputs from at least one user device via a communication network, wherein the first set of objects comprises at least one combination of a drivers, plug-in, network objects, virtual objects corresponding to the circuits and machines;
an analyzing module configured to analyze the received first set of objects and the first set of test inputs corresponding to the first set of objects;
a contextual sampling module configured to retrieve a set of relevant data corresponding to the first set of objects based on the analysis to test the first set of objects based on the set of relevant data and the first test inputs;
a testing module configured to determine first test results by testing the first set of objects based on the set of relevant data and the first test inputs;
a build module configured to provide a build environment to the at least one user device based on the determined first test results to receive a second set of objects from the at least one user device;
an evaluation module configured to evaluate the second set of objects received from the at least one user device along with the first set of objects previously received from the at least one user device;
a computation module configured to compute a first score based on the evaluation of the first set of objects and the second set of objects received from the at least one user device;
wherein the communication module is further configured to receive a second score from a host device; communicatively connected to the at least one user device based on the evaluation of the first set of objects and the second set of objects; and
wherein the computation module is further configured to compute an overall score based on the first score and the second score.

2. The system, as claimed in claim 1, wherein a data science method is used for classifying, predicting and suggesting the relevant for generating the relevant data corresponding to the first data objects.

3. The system, as claimed in claim 1, wherein the second score is computed using a capability score, a nonlinear bivariate map, and a scientific and technical validity value of a test case object.

4. The system, as claimed in claim 1, wherein the communication module is further configured to receive and store an activity data of the at least one user device, wherein the activity data comprises forward and backward compatibility of objects, combining the objects in proper form, improvements performed in the design the objects, using the virtual assistant, usage of expert opinion, errors, incorrect build, engineering limitation.

5. The system, as claimed in claim 1, wherein the system further comprises a virtual assistant manager for configuring a virtual assistant at the at least one user device to assist an user at the at least one user device.

6. The system, as claimed in claim 1, wherein the first score and the second score are computed based on technical ability to solve a problem of a user, mind state of the user, and approach towards the problem.

7. The system as claimed in claim 1, wherein the first score and the second score are computed by at least one of a category index, wherein the category index comprises an intellectual index (I), a compatibility index (C) and an emotional index (E).

8. The system as claimed in claim 7, wherein the overall score is computed based on a cumulative score of the intellectual index (I), compatibility index (C) and emotional index (E).

9. The system as claimed in claim 7, wherein the overall score is translated to scaled Grade Point Average (GPA) score, wherein the scaled GPA score corresponds to the intellectual index.

10. The system as claimed in claim 7, wherein the C index score is a quantitative measure of the interaction quotient of the individual.

11. The system as claimed in claim 7, wherein the E score is computed based on analysis of an emotional content using Natural Language Processing method (NLP)and Machine Learning (ML) method.

12. The system as claimed in claim 11, wherein the emotional content is analysed based on phrases corresponding to interaction data of the individual.

13. The system as claimed in claim 11, wherein the emotional content is classified as positive or negative emotions using a bayesian classifier.

14. The system, as claimed in claim 1, wherein to receive the first set of objects and the first set of test inputs from the at least one user device, the communication module is further configured to:
transmit an initial data objects received from the host device to the at least one user device based on user profile of a user associated with the at least one user device; and
receive in response to the initial data objects the first set of objects from the at least one user device along with the first set of test inputs.

15. The system, as claimed in claim 14, wherein to transmit the initial data objects the communication module is further configured to:
identify relevant data objects corresponding to the initial data objects received from the host device based on key word analysis; and
transmit the relevant data objects to the at least one user device.

16. A method for assessing an individual comprising:
receiving a first set of objects and a first set of test inputs, from at least one user device via a communication network, wherein the first set of objects comprises at least one combination of a drivers, plug-in, network objects, virtual objects corresponding to the circuits and machines;
analysing the received first set of objects and the first set of test inputs corresponding to the first set of objects;
retrieving a set of relevant data corresponding to the first set of objects based on the analysis to test the first set of objects based on the set of relevant data and the first test inputs;
determining first test results by testing the first set of objects based on the set of relevant data and the first test inputs;
providing a build environment to the at least one user device based on the determined first test results to receive a second set of objects from the at least one user device;
evaluating the second set of objects received from the at least one user device along with the first set of objects previously received from the at least one user device;
computing a first score based on the evaluation of the first set of objects and the second set of objects received from the at least one user device;
receiving a second score from a host device communicatively connected to the at least one user device based on the evaluation of the first set of objects and the second set of objects; and
computing an overall score based on the first score and the second score.

17. The method, as claimed in claim 16, wherein a data science method is used for classifying, predicting and suggesting the relevant for generating the relevant data corresponding to the first data objects.

18. The method, as claimed in claim 16, wherein the second score is computed using a capability score, a non linear bivariate map, and a scientific and technical validity value of a test case object.

19. The method, as claimed in claim 16, wherein the method further comprises receiving and storing an activity data of the at least one user device, wherein the activity data comprises forward and backward compatibility of objects, combining the objects in proper form, improvements performed in the design the objects, using the virtual assistant, usage of expert opinion, errors, incorrect build, engineering limitation.

20. The method, as claimed in claim 16, wherein the method further comprises configuring a virtual assistant at the at least one user device to assist a user at the at least one user device.

21. The method, as claimed in claim 16, wherein the first score and the second score are computed based on technical ability to solve a problem of a user, mind state of the user, and approach towards the problem.

22. The method as claimed in claim 16, wherein the first score and the second score are computed by at least one of a category index, wherein the category index comprises an intellectual index (I), a compatibility index (C) and an emotional index (E).

23. The method as claimed in claim 22, wherein the overall score is computed based on a cumulative score of the intellectual index (I), compatibility index (C) and emotional index (E).

24. The method as claimed in claim 22, wherein the overall score is translated to scaled Grade Point Average (GPA) score, wherein the scaled GPA score corresponds to the intellectual index.

25. The method as claimed in claim 22, wherein the C index score is a quantitative measure of the interaction quotient of the individual.

26. The method as claimed in claim 22, wherein the E score is computed based on analysis of an emotional content using Natural Language Processing method (NLP) and Machine Learning (ML) method.

27. The method as claimed in claim 26, wherein the emotional content is analysed based on phrases corresponding to interaction data of the individual.

28. The method as claimed in claim 26, wherein the emotional content is classified as positive or negative emotion using a bayesian classifier.

29. The method, as claimed in claim 16, wherein receiving first set of objects and the first set of test inputs from the at least one user device comprises:
transmitting an initial data objects received from the host device to the at least one user device based on user profile of a user associated with the at least one user device; and
receiving in response to the initial data objects the first set of objects from the at least one user device along with the first set of test inputs.

30. The method, as claimed in claim 29, wherein the transmitting the initial data objects comprises:
identifying relevant data objects corresponding to the initial data objects received from the host device based on key word analysis; and
transmitting the relevant data objects to the at least one user device.
